(19) United States
(12) Patent Application Publication
(10) Pub. No.: US 2025/0320146 A1
(43) Pub. Date: Oct. 16, 2025

(54) DEWATERING DEVICE AND RELATED METHODS

(71) Applicant: Nathan Kusalich, Fresno, CA (US)

(72) Inventor: Nathan Kusalich, Fresno, CA (US)

(21) Appl. No.: 18/633,511

(22) Filed: Apr. 12, 2024

(51) Int. Cl. C02F 11/122

(52) U.S. Cl. CPC C02F 11/122

(57) ABSTRACT

A collection head operable to draft water from mud deposits. The collection head includes a filter and collection pipe assembly to receive mud and filter out sediments. A blocking plate is placed at the surface of a water or mud deposit, from which water is drafted and sediments are removed.

### FIELD OF THE INVENTION

The present invention relates generally to a collection device for drafting water from mud and other similar deposits. More particularly, the present invention provides a collection pipe and blocking plate assembly that is operable to draft water from mud deposits while minimizing the amount of sediment and earth that is collected during water collection and removal.

### BACKGROUND OF THE INVENTION

The removal of water from a construction site is a critical process in the field of construction and civil engineering, pivotal for ensuring the integrity, safety, and timely completion of construction projects. This task, often referred to as dewatering, involves the extraction of water from the soil or surface at a construction site to create a dry and stable working environment. The necessity and significance of removing water from construction sites are multifaceted, encompassing technical, environmental, and economic perspectives.

Water presence in the soil can severely affect its physical properties, reducing shear strength and increasing the likelihood of soil liquefaction under load. This can lead to foundation instability, uneven settlement, or even catastrophic failure of the structure. Waterlogged sites pose significant safety risks for personnel and machinery. Slippery conditions, cave-ins, and equipment malfunction or failure are more likely, increasing the risk of accidents and delays. Water in the construction site can also interfere with the setting and curing of concrete, reduce compaction efficiency in earthworks, and compromise the integrity of the structure. Ensuring a dry base is essential for achieving the desired strength and durability of construction materials.

Extracting water is also critical to a variety of other industries, including the environmental and resource management industries. For many regions across the globe, water is a limited resource. In some instances, the available water may not be usable or potable. Therefore, there exists a need for devices that extract water from deposits such as mud, a readily available resource. Mud may be found in areas of large oil deposits or industrial accidents, and may appear after torrential rains in certain areas. Removing this mud from the environment may not only provide a readily available source of water but may improve the environment as a whole. Many such devices and methods exist that can extract mud including filtration systems, centrifugal separators, and sedimentation tanks.

The removal of water from a construction site is a critical process that significantly influences the structural integrity, safety, environmental impact, and economic viability of construction projects.

### SUMMARY OF THE INVENTION

The present invention provides an improved water collection head for a dewatering system. The improved water collection head may be operable to draw water through a collection conduit while blocking the collection of solid particles from water and mud deposits to remove water from job sites and other areas that should be dewatered. The collection head may be included in a mobile dewatering system is designed to rapidly deploy to different locations (e.g., construction sites) to extract water from surface deposits, trenches, or excavations. In some embodiments, the dewatering system may include a vehicle equipped with a mounted tank, a water collection head with a blocking plate, an integrated pump, a filtration unit, and a control system for operation and monitoring.

In some embodiments, the collection head may include an intake port, collection pipe, blocking plate, receiver pipe, and filter assembly. The blocking plate has upturned corners and may also have upturned lateral edges. The plate may be placed or pressed into a puddle on the ground surface, where water or mud deposits are present. The blocking plate breaks the surface of the water, allowing the water to spill over the upturned corners and edges of the blocking plate, while blocking the incursion of solid particles.

The blocking plate may be attached to the collection pipe, which may be operable to collect the water that spills over the blocking plate. Some solid particles may be collected by the apparatus. In some embodiments, there may be a filter structure at or near the connection of the blocking plate and the collection pipe to prevent the passage of solid particles from the blocking plate through the pipe. In some examples, the filter may be placed in line to the collection pipe, in some respective embodiments. The filter may be operable to separate solid materials from the water as it passes through the collection head. Solid materials may be separated from water through the perforations in the surface of the filter. The filter gauge may be in a range of about ⅛ inches to ½ inches (e.g., about ¼″ to about ⅜ inches, or any value or range of values therein).

In some embodiments, there may be a fluid pump, operable to pump fluid through the pipe and create suction at the blocking plate. The external fluid pump may be connected to the collection pipe by a hose. The pump may be a centrifugal pump, diaphragm pump, reciprocating pump, or other type of fluid pump.

In some implementations, the collection head may extract water from shallow water or mud deposits. For example, the collection head may extract water from a depth of in a range between ¼ inch to 48 inches. The depth level of the puddle or mud deposit may affect the efficiency of the blocking plate in preventing the incursion of solid particles, and thus the collection head is more beneficially used within shallow conditions. In exemplary embodiments, the collection head may draft water from mud at higher depth levels. In deeper water conditions, a float may be attached to the hose to keep the hose supported and open during operation of the collection head.

The collection head may draught water from water and mud deposits at a defined depth level using a blocking plate, collection pipe with suction pump, and optionally a filter assembly. The water may flow to an external reservoir for collection with a significantly reduced sediment load.

It is an object of the present invention to provide a dewatering system is to lower the groundwater level or remove surface water, thus preventing water accumulation that could hinder construction activities, compromise structural foundations, or lead to safety hazards.

It is an object of the present invention to provide a specialized collection head for removing water from construction sites and other sites where water and mud are undesirable.

It is an object of the present invention to provide a specialized collection head with a blocking plate for removing water from water or mud deposit that prevents collection of sediment with the extracted water.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 shows a perspective view of a collection head, according to an embodiment of the present invention

FIG. 2a shows a first side view of a collection head, according to an embodiment of the present invention

FIG. 2b shows a second side view of a collection head, according to an embodiment of the present invention

FIG. 3a shows a rear view of a collection head, according to an embodiment of the present invention

FIG. 3b shows a front view of a collection head, according to an embodiment of the present invention

FIG. 4 shows a perspective view of a collection head having a filter, according to an embodiment of the present invention

FIG. 5a shows a first side view of a collection head having a filter, according to an embodiment of the present invention

FIG. 5b shows a second side view of a collection head having a filter, according to an embodiment of the present invention

FIG. 6a shows a front view of a collection head having a filter, according to an embodiment of the present invention

FIG. 6b shows a rear view of a collection head having a filter, according to an embodiment of the present invention.

FIG. 7 shows an environmental view of the collection head, according to an embodiment of the present invention.

FIG. 8 shows an environmental view of the collection head, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

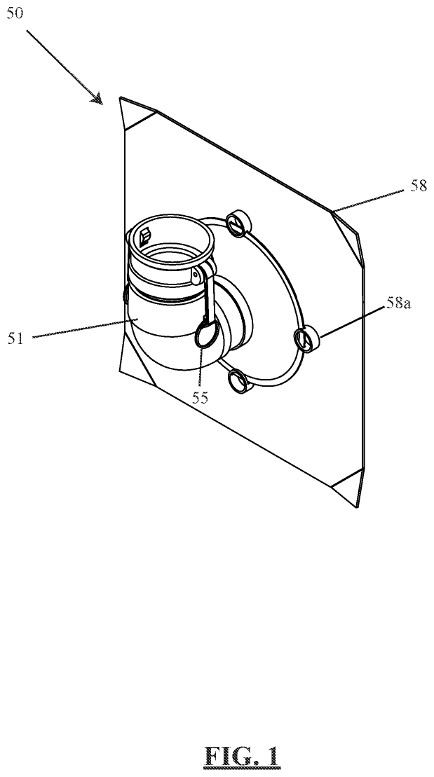

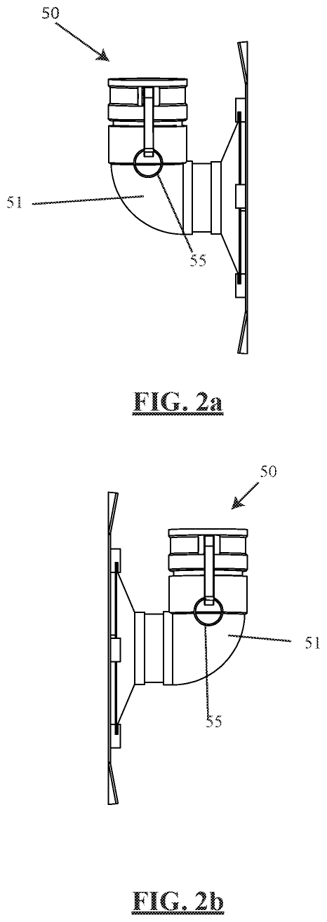

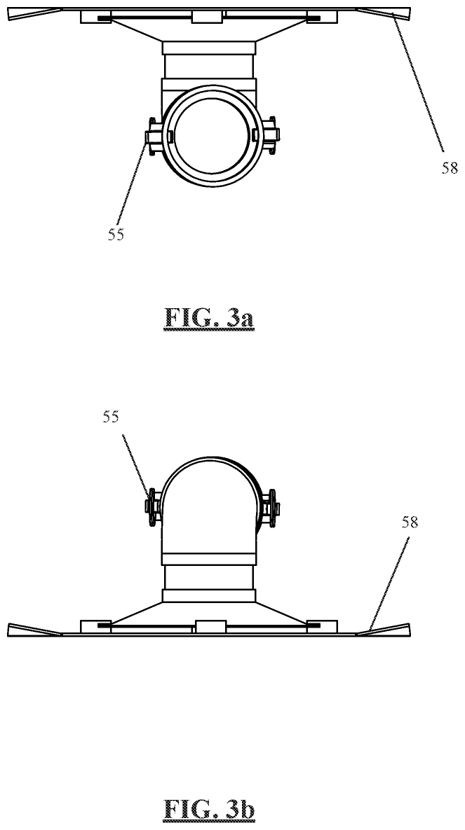

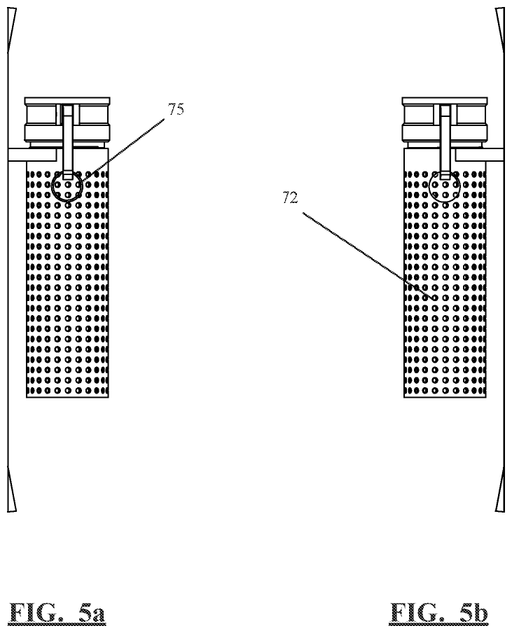

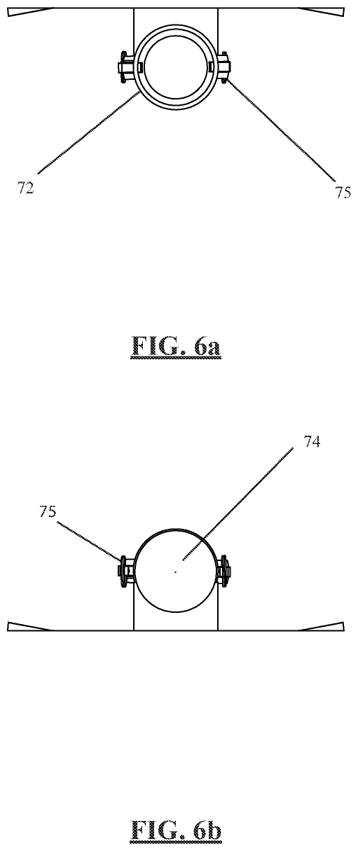

Referring to the drawings, wherein like reference characters designate like or corresponding parts throughout the several views, and referring particularly to FIGS. 1-7, it is seen that the present invention includes various embodiments of collection head assembly operably incorporated with a filter to separate sediments or solid particles from mud and draft water.

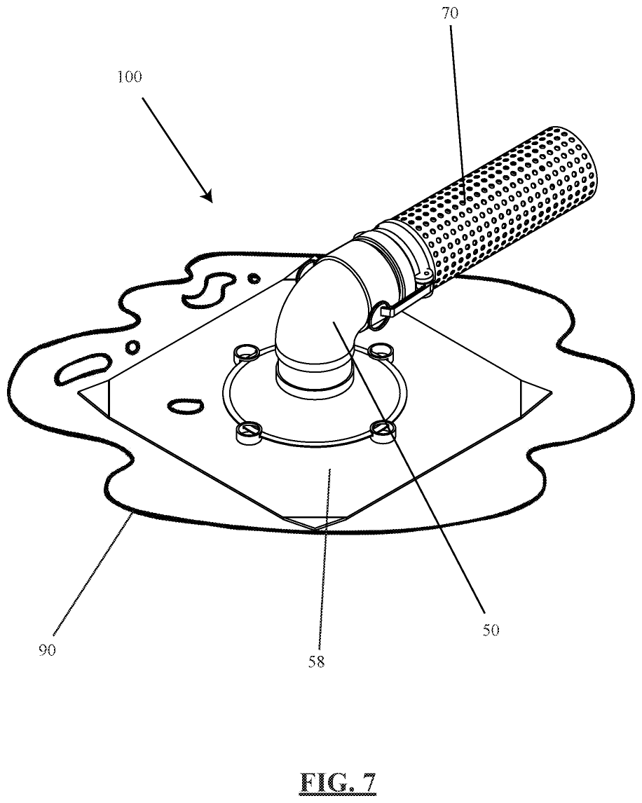

The present invention describes a filtration device 100, with collection pipe assembly 50, filter assembly 70, and blocking plate 58, as shown in FIG. 7. Collection pipe assembly 50 may include a collection pipe 51, mounting bracket 58a, and blocking plate 58.

### Collection Pipe (Elbow)

In some embodiments, the collection pipe 51 may be operable to pump mud using a fluid pump 105 when the blocking plate 58 is positioned on the a ground surface. The collection pipe 51 may be attached to a mounting bracket 58a, which is operably secured to the blocking plate 58. The collection pipe assembly 50 may include a clamping mechanism 55, operable to latch on to additional piping and provide a tight seal. In some embodiments, mounting bracket 58a may include a plurality of tabs operable to secure itself to blocking plate 58.

The collection pipe may have an angle along its length for purposes of routing a collection hose to a collection receptacle. In some embodiments, when mud flows through collection pipe 51, the angle of the collection pipe 51 may range between 90 to 150 degrees. In some embodiments, the collection pipe 51 may be similar to an elbow flange with an angle of 90 degrees.

The flow rate at which mud may travel along the collection head may be directly related to the size of the collection conduit 74, collection pipe 51 angle, and the properties of the mud or other liquid. In some embodiments, the flow rate of the mud may be estimated around 150 to 250 gallons per minute with a 3-inch diameter collection pipe and conduit and a 90-degree “elbow” in collection pipe 51. In other embodiments, the flow rate may be increased or decreased based on collection pipe and conduit diameter, angles in the collection pipe, and the pressure created by the pump in fluid communication with the collection conduit.

In some embodiments the clamping mechanism 55 may be designed as a toggle clamp, over-center latch, or draw latch. Access to the collection head 100 may be necessary to monitor performance. Therefore, adding clamping mechanism 55 to the collection head 100 may reduce maintenance costs and improve the safety of the overall system by providing a secure seal of the mud deposit and other liquids. In other embodiments, the clamping mechanism 55 may be operable to perform other functions than described.

### Filter Assembly

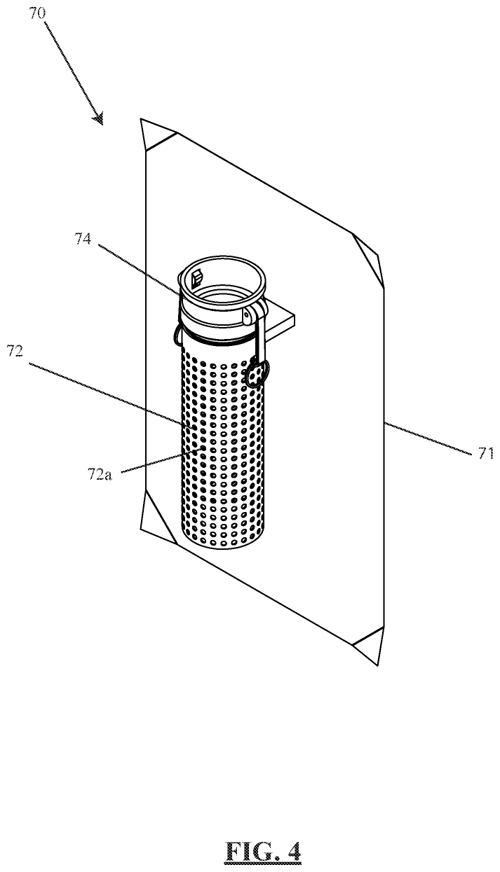

In some embodiments, the collection head 100 may be operable to filter solid particles from mud deposits using a filter assembly 70, as shown in FIGS. 4-7. The filter assembly 70 may be operably attached inline to the collection pipe 51 through clamping mechanism 75. Receiver pipe 74 may be operably attached to the collection pipe 51 through clamping mechanism 75. In some embodiments, the filter assembly may include a filter 72, plate 58, receiver pipe 74, and clamping mechanism 75, as shown in FIG. 4. The filter 72 may be nested within a collection conduit 102 upstream of a pump or collection receptacle. Additional conduit may be placed at the discharge portion of the filter 72 to direct the water to a refinery, or other water filtration plant. In some embodiments, the collection head 100 may be operable to filter other liquids besides mud. Some liquids that may be filtered by the collection head 100 include waste water, storm water, industrial process water, and other liquids.

As water flows through the receiver pipe 74, the filter 72 may filter out sediments and draft the water through the collection head 100. The filter 72 may include at least one perforation 72a to remove sediments from the mud, in some embodiments. In other embodiments, the filter 72 may include a plurality of perforations 72a operable to remove a plurality of sediments from mud deposits.

During a filtration procedure, the plurality of perforations 72a within filter 72 may be sized such that sediments from mud are unable to pass through while the remaining liquid is allowed to flow. Perforation 72a may be circular in shape and its diameter may range between ¼″ and 0.5 inches, in some respective embodiments. In other embodiments, the filter 72 may include perforations 72a of different diameters and of different shapes.

For example, perforations 72a may accumulate a plurality of solid particles within their contours, effectively removing the sediments from the mud and allowing for the water to flow freely. In other embodiments, the solid particles may be pushed out of perforations 72a during drafting of water. In some embodiments, the filter 72 may include a plurality of perforations 72a each with a plurality of shapes and a plurality of diameters to separate more robust sediments.

### Blocking Plate

Blocking plate 58 may be operable to provide a stable foundation for the collection head 100. In some embodiments, the ground surface near a water or mud deposit 90 may shift and become uneven. The blocking plate 58 may distribute the weight of the collection head 100 over a larger area, reducing vibrations and instabilities that may occur during the drafting process.

In some embodiments, the blocking plate 58 may include a mounting bracket 58a, serving as the primary receiver for the collection pipe 51. The mounting bracket 58a may be operable to receive mud deposits and receive a collection pipe assembly 50.

### Collection Head

The collection head 100 may be securely fixed to the ground near a mud deposit 90 using a blocking plate 58, as shown in FIG. 7. Collection pipe 51 may draw in water 90, allowing it to travel along to filter 72, thus removing the sediments and contaminants from any mud. Perforations 72a may trap solid materials, allowing for the water to flow through. Filter 72 may be operably attached to the collection pipe 51 through a clamping mechanism 55.

Extracting, or rather drafting, water from mud may be limited to a certain depth level. In some embodiments, the collection head 100 may draft water from mud deposits 90 with depth levels ranging between ¼ inches and 48 inches. In other embodiments, the depth level may be different from described.

In other embodiments, the filter assembly 70 may receive additional piping (not shown) that extends the length of the collection head 100. The conduit 102 may deliver the water towards an external reservoir or refinery (not shown). Additional piping or tubing may be attached to the discharge portion of filter 72 through clamping mechanism 55, in most embodiments.

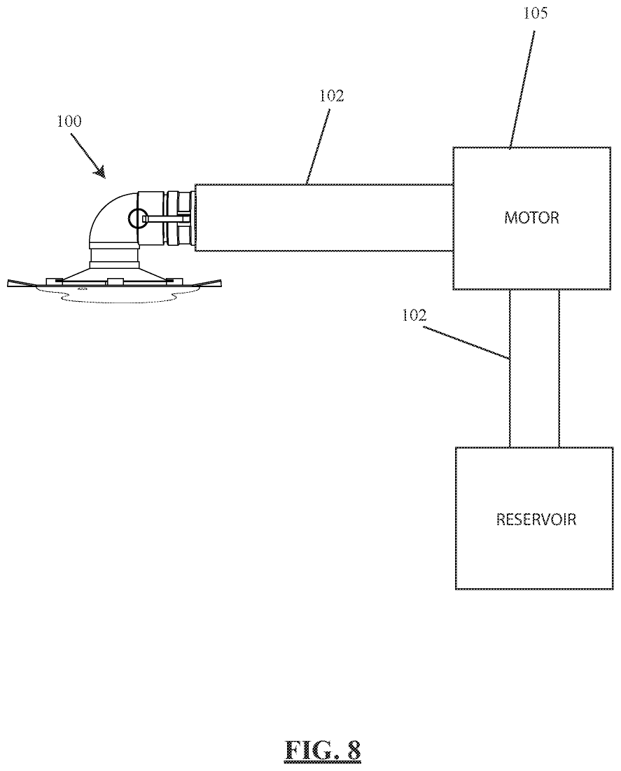

In some embodiments, there may be an external fluid pump 105 operable to pump the mud deposit through collection head 100, as shown in FIG. 8. A collection conduit 102 may be placed in-line with collection head 100, specifically filter assembly 70, which may be embedded within hose 102. Pumping the mud through collection head 100 may increase the flow rate of mud, thereby improving the efficiency of the overall system. In some exemplary embodiments, the collection head 100 may deliver the filtered mud towards a reservoir for further filtration through collection conduit 102 and fluid pump 105.

Water deposits including sediment and mud deposits may be highly corrosive and abrasive, creating substantial amounts of rust and corrosion. Therefore, the collection head 100 may utilize materials that may present strength, durability, and resistance to mud deposits. For example, some materials for the collection pipe assembly 50, filter 72, and blocking plate 58 may include stainless steel, carbon steel, aluminum, brass, cast iron, and the like. In other embodiments, the collection head 100 may utilize other corrosion-resistant materials, such as polyvinyl chloride (PVC), Chlorinated Polyvinyl Chloride (CPVC), High-Density Polyethylene (HDPE), Polypropylene (PP), Polybutylene (PB), and other high strength polymer materials.

Examples of mud deposits may include puddles, swamps, river banks, construction sites, agricultural fields, and the like. In most embodiments, the collection head 100 may be operable to draft water from such environments.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A water collection head, the device comprising:
a. a blocking plate having a top surface securing a diverging nozzle intake and a bottom surface positioned in a water sediment slurry;
b. a collection pipe having a first end secured to said diverging nozzle and a second end securing a locking mechanism operable to secure a filter assembly; and
c. a filter positioned in said filter assembly operably secured to a fluid pump.
wherein said filter is operable to filter solid materials from a water sediment slurry deposit available from said ground surface redirected through a fluid pump from said blocking plate and collection pipe, thereby allowing a flow of water through said water collection head.

2. The device of claim 1, wherein said water sediment slurry comprises of water, organic matter, rocks, sand, dirt, and gravel.

3. The device of claim 2, wherein said filter is operable to separate sediments with diameters ranging between 0.25 inches to 0.375 inches from said water sediment slurry.

4. The device of claim 2, wherein said filter is operable to separate sediments with a plurality of diameters from said water sediment slurry.

5. The device of claim 1, wherein said filter includes at least one perforation operable to separate water and solid materials from said water sediment slurry.

6. The device of claim 2, wherein said at least one perforation is a plurality of perforations operable to separate water and solid materials from said water sediment slurry.

7. The device of claim 1, wherein said blocking plate comprises of a top and bottom surface.

8. The device of claim 4, wherein said top surface comprises of a gap between said diverging nozzle.

9. The device of claim 4, wherein said bottom surface engages with the ground surface near said water sediment slurry.

10. The device of claim 1, wherein said collection pipe is an elbow operable to reduce headloss of said sediment slurry.

11. (canceled)

12. (canceled)

13. (canceled)

14. (canceled)

15. (canceled)

16. A water and sediment separation device, the device comprising:
a. a blocking plate positioned in a water slurry mixture, said base including a plurality of tabs that are operable to secure an intake at an offset;
b. an adapter having a first end coupled to said intake on a first end and a second end coupled to a filter assembly; and
c. a conduit secured to said filter assembly and secured to a fluid pump.
wherein said fluid pump is engaged and said water slurry mixture is routed between said blocking plate and said intake and said filter assembly is operable to separate sediment from water and is routed along said conduit to a water collection apparatus.

17. The device of claim 11, wherein said fluid pump is operable to engage with water slurry mixtures with depth levels ranging between ¼ and 48 inches.

18. (canceled)

19. (canceled)

20. (canceled)

21. (canceled)

22. (canceled)

23. A method for separating water and sediment from a mud slurry, the method comprising:
a. positioning a water and sediment separator in a mud slurry, said water and sediment separator comprising:
i. a blocking plate securing an intake; and
ii. a collection conduit having an attachment mechanism that is operable to secure a filter assembly;
b. attaching a conduit to said filter assembly;
c. attaching a fluid pump to said conduit;
d. engaging said fluid pump with slurry mixture
wherein said water and sediment separator engages with the ground surface near said mud slurry and said fluid pump, separating sediments from the mud slurry.

24. The method of claim 23, wherein said fluid pump is operable to reduce the head loss of said water and sediment separator.

25. The method of claim 23, wherein water and sediment separator may be operable to separate sediments with diameters ranging between 0.25 inches and 0.75 inches.

26. The method of claim 23, wherein said collection conduit comprises of an angle ranging between 90 and 150 degrees.

27. The method of claim 23, wherein said filter assembly includes at least one perforation operable to separate sediments from said slurry mixture.

28. (canceled)

29. The method of claim 23, wherein said blocking plate comprises of a top and bottom surface.

30. The method of claim 29, wherein said top surface engages with said water and sediment separator.

31. The method of claim 29, wherein said bottom surface engages with ground surface near said mud slurry.

32. (canceled)
